(19) United States
(12) Patent Application Publication
(10) Pub. No.: US 2021/0350662 A1
(43) Pub. Date: Nov. 11, 2021

(54) SYSTEM AND METHOD FOR FACILITATING SAFETY PROTOCOLS IN CASINO GAMING FLOOR OPERATIONS

(71) Applicant: Win Technologies Limited, Marsa (MT)

(72) Inventor: Eric Benchimol, Barcelona (ES)

(21) Appl. No.: 16/951,792

(22) Filed: Nov. 18, 2020

Related U.S. Application Data
(60) Provisional application No. 63/021,050, filed on May 6, 2020.

(51) Int. Cl. G07F 17/32

(52) U.S. Cl. CPC G07F 17/3239; G07F 17/3227

(57) ABSTRACT

System and methods for monitoring and controlling one or more gaming devices on a gaming floor in which a gaming device controller enables and disables gaming devices pursuant to compliance with safety protocols such as social distancing requirements.

### CROSS-REFERENCE TO RELATED APPLICATION

This application claims the priority benefit of U.S. provisional patent application No. 63/021,050 filed on May 6, 2020, the disclosure of which is incorporated herein by reference.

### FIELD OF THE INVENTION

The invention is directed to systems and methods for controlling gaming floor operations, and more particularly, systems and methods for applying social distancing between players of electronic gaming machines through casino management systems without changing the current position and configuration of electronic gaming machines in a gaming establishment.

### BACKGROUND OF THE INVENTION

There are current and persisting concerns about the spread of infectious agents such as COVID-19 amongst people and through the ability of such infectious agents to remain infectious on the surface of inanimate objects. Thus, the practices of “social distancing” from others, generally thought to be no less than six feet, and disinfecting items that may be used by multiple people are now recommended if not required.

Some business operators provide facilities that are designed to provide services or products to individual customers while those customers are adjacent to one another. For example, electronic gaming machines offered by gaming operators in a gaming establishment are generally positioned adjacent to one another, and most often well within a six foot range from one another. Seats for such machines are also within six feet of each other and therefore the current configuration of electronic gaming machines would result in gaming machine players failing to comply with the recommended, if not required, social distancing protocol of maintaining at least six feet of distance between people.

Gaming establishments generally spend a great deal of time and effort in designing the gaming floor and selecting the location of electronic gaming machines. Changing the current position and configuration is problematic at least because many gaming machines will have to be removed to ensure social distancing between players. Gaming machines are usually bolted into the floor and wired for power and connection to the casino management system. Thus, removing gaming machines to satisfy social distancing rules requires substantial time and effort. Even if possible, the removal of gaming machines means less options for gaming machine players and does not provide for the gaming machines that have surfaces which are free of potential infectious agents. Less gaming machines would therefore also reduce the availability of gaming machines that could be available while a gaming machine is unavailable while being disinfected after a game session is completed.

Accordingly, there is a need in the art for systems and methods which enable business operators having facilities that would normally place individual customers adjacent one another, such as gaming establishments, to protect their customers without having to make substantial changes or provide less options for use.

### SUMMARY OF THE INVENTION

The invention relates to systems and methods for resolving the aforementioned issues, among other things, and which are configured to facilitate improved management operations of a casino gaming floor, including providing for social distancing protocols in gaming floor operations through the detection and control of gaming activity at gaming devices on the casino gaming floor in a manner which avoids having to reposition gaming devices on the gaming floor while also allowing for all gaming devices on the gaming floor to remain available for play.

Some embodiments of the invention are directed to systems for monitoring and controlling one or more gaming devices on a gaming floor, comprising: one or more gaming devices positioned on the gaming floor, wherein the gaming devices are interconnected by a network; and a gaming device controller, including one or more data processors, memory and a data communication device, the gaming device controller being interconnected with the one or more gaming devices and a data storage device by the network, the data storage device storing a map of the gaming floor with a game identification of each gaming device and the position of the one or more gaming devices on the gaming floor, wherein the gaming device controller is configured to detect data transmissions generated by the one or more gaming devices, the transmissions being indicative of a game session activity, a pre-game session activity, a game session available state, a game session active state and a game session deactivation state, wherein the gaming device controller is configured to alternate the state of the one or more gaming devices at least between the game session available state and the game session deactivation state, wherein the game session available state enables a user-initiated activation of a game session on the one or more gaming devices and the game session deactivation state disables the one or more gaming devices for the user-initiated activation of a game session, and wherein responsive to the gaming device controller detecting the pre-game session activity on a selected gaming device of the one or more gaming devices in the game session available state, the gaming device controller enabling the selected gaming device for a game session responsive to a determination based on the map that the selected gaming device and a one or more unselected gaming devices satisfy a preset criteria, the gaming device controller alternating the state of the one or more unselected gaming devices to the game session deactivation state responsive to the preset criteria being satisfied.

In some embodiments of the aforementioned system the preset criteria is satisfied responsive to the one or more unselected gaming devices being in one of the game session available state and the game session deactivation state.

In some embodiments of the aforementioned system the preset criteria comprises a geographical range of the one or more unselected gaming devices relative to the geographical location of the selected gaming device being in the game session available state or the game session deactivation state, wherein the gaming device controller alternates the state of only the one or more unselected gaming devices within the geographical range to the game session deactivation state responsive to the preset criteria being satisfied.

In some embodiments, responsive to the preset criteria being satisfied, the gaming device controller actuates a visual indication of the game session deactivation state on a display device associated with the one or more unselected gaming devices within the geographical range.

In some embodiments, the gaming device controller determines based on the map an alternative gaming device having the same game identification as the one or more unselected gaming devices within the geographical range.

In some embodiments, the gaming device controller actuates a visual indication of the position on the gaming floor of the alternative gaming device on a display device associated with the one or more unselected gaming devices within the geographical range.

In some embodiments of the aforementioned system, responsive to the preset criteria being satisfied, the gaming device controller actuates a visual indication of the game session deactivation state on a display device associated with the one or more unselected gaming devices.

In some embodiments of the aforementioned system the preset criteria is not satisfied responsive to the one or more unselected gaming devices being in the game session active state.

In some embodiments of the aforementioned system responsive to the preset criteria not being satisfied, the gaming device controller determines based on the map an alternative gaming device of the one or more unselected gaming devices in the game session available state that satisfies the preset criteria.

In some embodiments of the aforementioned system the gaming device controller determines based on the map the alternative gaming device having the same game identification as the selected gaming device.

In some embodiments of the aforementioned system the gaming device controller actuates a visual indication of the position on the gaming floor of the alternative gaming device on a display device associated with the selected gaming device.

In some embodiments of the aforementioned system the gaming device controller is further configured to alternate the state of the selected gaming device to the game session deactivation state responsive to the gaming device controller detecting the cessation of game session activity on the selected gaming device.

In some embodiments of the aforementioned system the gaming device controller is further configured to alternate the state of the one or more unselected gaming devices to the game session available state responsive to the gaming device controller alternating the state of selected gaming device to the game session deactivation state and the preset criteria being satisfied.

In some embodiments of the aforementioned system the gaming device controller is further configured to receive an identification of the selected gaming device of the one or more gaming devices, a date and a time, and responsive thereto, alternate the state of the selected gaming device and the one or more unselected gaming devices to a game session deactivation state.

In some embodiments of the aforementioned system the pre-game session activity comprises receiving a signal indicative of establishing credit on the selected gaming device or detection of physical contact with a user interface on the selected gaming device.

Some embodiments of the invention are directed to a method for monitoring and controlling one or more gaming devices on a gaming floor in a casino having one or more gaming devices positioned on the gaming floor, wherein the gaming devices are interconnected by a network, and a gaming device controller, including one or more data processors and a data communication device, the gaming device controller being interconnected with the one or more gaming devices and a data storage device by the network, the data storage device storing a map of the gaming floor with an identification of each gaming device and the position of the one or more gaming devices on the gaming floor, wherein the gaming device controller is configured to detect data transmissions generated by the one or more gaming devices, the transmissions being indicative of a game session activity, a pre-game session activity, a game session available state, a game session active state and a game session deactivation state, wherein the gaming device controller is configured to alternate the state of the one or more gaming devices at least between the game session available state and the game session deactivation state, wherein the game session available state enables a user-initiated activation of a game session on the one or more gaming devices and the game session deactivation state disables the one or more gaming devices for the user-initiated activation of a game session, the method comprising the steps of: a) responsive to the gaming device controller detecting pre-game session activity on a selected gaming device of the one or more gaming devices in the game session available state, the gaming device controller determining based on the map that the selected gaming device and a one or more unselected gaming devices satisfy a preset criteria; b) the gaming device controller alternating the state of the one or more unselected gaming devices to the game session deactivation state responsive to the preset criteria being satisfied; c) the gaming device controller actuating a visual indication of the game session deactivation state on a display device associated with the one or more unselected gaming devices; d) the gaming device controller alternating the state of the selected gaming device to the game session deactivation state responsive to the gaming device controller detecting the cessation of game session activity on the selected gaming device; and e) the gaming device controller alternating the state of the one or more unselected gaming devices to the game session available state responsive to the gaming device controller alternating the state of selected gaming device to the game session deactivation state and the preset criteria being satisfied.

In some embodiments of the aforementioned method, the preset criteria comprises a geographical range of the one or more unselected gaming devices relative to the geographical location of the selected gaming device being in the game session available state or the game session deactivation state, wherein the gaming device controller alternates the state of only the one or more unselected gaming devices within the geographical range to the game session deactivation state responsive to the preset criteria being satisfied.

### BRIEF DESCRIPTION OF THE DRAWINGS

FIG. 1 is a diagram of a casino management system modified or constructed according to some embodiments of the invention; and

FIG. 2 is a process flow diagram of an embodiment of the invention which may be employed in a casino management system as shown in FIG. 1.

### DETAILED DESCRIPTION OF SOME EMBODIMENTS OF THE INVENTION

The embodiments of the invention disclosed herein relate to a system for enabling social distancing in the play of gaming devices at a casino game. More particularly, the present invention relates to an improved casino management system in communication with gaming devices within a casino environment that enables various features for enabling the gaming devices for game play and disabling the gaming devices for game play adjacent responsive to comparison with the gaming device location and preset social distancing protocols, among other things.

In the following description of the preferred embodiment, reference is made to the accompanying drawing that form a part hereof, and in which is shown by way of illustration specific embodiments in which the invention may be practiced. It is to be understood that other embodiments may be utilized and that changes may be made without departing from the scope of the invention. Reference will now be made in detail to the preferred embodiments of the invention, examples of which are illustrated in the accompanying drawing.

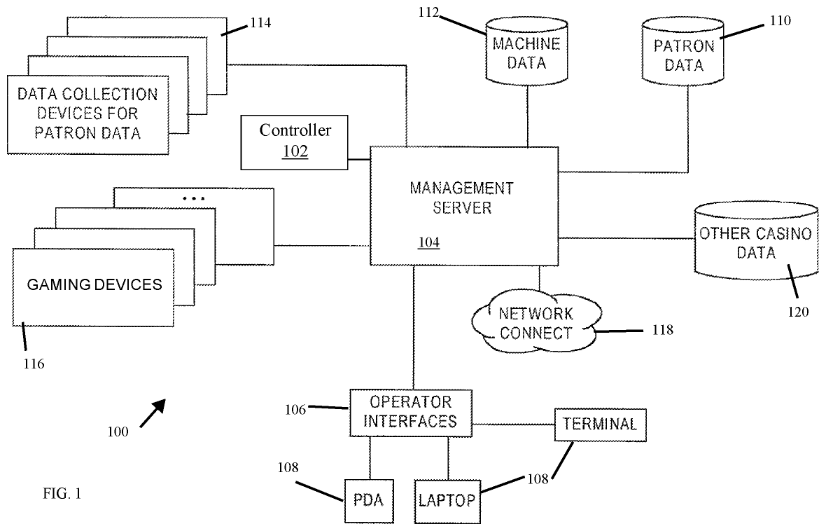

FIG. 1 illustrates the software execution and hardware components of an exemplary embodiment of the invention incorporated in a computer-based casino management system generally designated by reference numeral 100 which may include both convention and unconventional elements that cooperate within a network to provide for secure management and controls of varied gaming devices on a gaming floor.

Casino management system 100 includes a controller 102 and a management server 104 comprising one or more computing hosts that can be located locally or remotely to a gaming establishment, also referred to herein as a casino or casino resort. It should be understood that a management server 104 can be provisioned for a single casino or for multiple casinos, and may include single or multiple components. It should also be understood that the elements shown in FIG. 1 may not represent all elements used in a casino management system 100 constructed in accordance with the invention and such components may not be depicted in FIG. 1 to facilitate this description and illustration shown in FIG. 1. Components depicted may also be combined or separated with one another. For example, controller 102 may be in communication or incorporated with management server 104, though these components may be shown and described separately herein.

Casino personnel interact with management server 104 via the operator interface 106 that can run on wireless or wired computers, laptops or PDAs that can be remotely or locally located. This interface 106 provides displays as well as permits operators to enter, edit and delete data from the server 104. The interface 106 can include means for connecting data collection devices 108, such as mobile devices or PDAs, laptops and terminals, in order to acquire data collected from remote gaming devices or gaming devices that do not communicate directly with server 104. The management server 104 also communicates with data warehouses that store patron related data 110 and machine location and performance data 112. These databases can be remotely or locally located and can be a single warehouse or different databases. Within the casino, apparatuses are used at gaming devices, such as slot machines, terminals, stations, and non-gaming devices, such as ticket windows, funds cages and other attractions which are in communication with server 104 to be controlled thereby and collect data about patrons 114, such as player loyalty systems for example. Server 104 is also in communication with gaming devices 116 to collect data and control operation of the gaming devices 116, which includes any gaming operation on the floor, such as gaming machines, electronic gaming tables and live gaming tables, each of which may include one or more display devices, memory, processors, interface boards (such as slot machine interface boards), random number generators, user interfaces (such as touchscreens or buttons), currency acceptors and player card reading devices associated therewith. These data collection devices 114 and gaming devices 116 often crossover and are networked together and communicate with the management server 104 by either polling methods or by self-initiated communication. Alternatively, data collection devices 114 and gaming devices 116 can collect and store data and then download the collected data to an operator database which is periodically used to acquire the collected data throughout a casino and communicate with server 104.

Controller 102 of casino management system 100 accesses information, monitors and controls gaming devices 116 through server 104. Controller 102 may provide various displays on operator interface 106 such as a map or graphical model of the casino layout so that the geographical location or position, operation and performance of gaming devices 116 with an identification of the game, such as by game name or type, can be presented visually. In such an arrangement, a casino layout in 2 or 3 dimensions is created and stored for use by both controller 102 and the server 104. An operator can therefore visually identify a location in the casino by selecting that location from the visual display and view the performance and operation of the device or devices 116 at that location.

Controller 102 also receives information or otherwise detects the status of activity at gaming devices 116, such as whether a game session is activated or a game session has ended, which may be through the detection or transmission of data signals generated internally by gaming devices 116 responsive to changes of state, detection of activity, or other events occurring at the gaming devices 116. Controller 102 is also able to detect whether certain types of pre-game session activity or non-game session activity events occur at gaming devices 116, such as contact with a gaming device user interface, such as buttons or a touch screen, the reading of a player card, receipt of funds (electronically, through a ticket or currency). Controller 102 may cause the information detected to be visualized on the map of the casino layout thus indicating a state of gaming devices 116 on the map.

Additional communication with system 100 is provided through a network connection 118 and server 104 can maintain and store information in database 120 relating to gaming machines and floor locations in the casino, casino personnel, such working schedules and assignments along with other information which can facilitate contact tracing, and social distancing criteria for comparison with various operations by server 104, such as gaming machine activity and cleaning, which may be used by system 104 to automatically determine which personnel to dispatch to a certain part of a casino or a particular gaming machine.

Casino management system 100 is an exemplary system having components such as controller 102 and management system 104, among others, which can be enabled to provide various features such as those described below, at least some of which enable the casino to operate gaming machines in compliance with recommended or required social distancing and hygienic practices, without the need to alter a gaming floor or install dividers or other physical features, while also keeping the gaming machines available for play.

System 100, through communication with gaming devices 116 can enable features such as the automatic disabling of adjacent machines. System 100 receives a communication from a gaming device 116 via server 104 that a user has selected to initiate a gaming session on a gaming device 116. Server 104 communicates with controller 102 which compares the stored gaming floor layout or map and determines the position of the selected gaming device 116 and automatically disables other “unselected” gaming devices 116 in order to maintain social distancing practices. For example, controller 102 may identify other gaming devices 116 which are either positioned within a preset distance, such as a radius of six feet, or which may result in another patron or casino personnel from being within a radius of six feet of a player at the initiated gaming device 116, and then disable those gaming devices 116 or additional positions at the initiated gaming device 116, such as in instances of a multi-position gaming machine or live table game. Controller 102 may disable one or more gaming devices 116 that satisfy a preset criteria, such as being within the determined range, by making a change to the state of the one or more gaming devices 116 or components thereof to a disabled or deactivated state, such as by turning off each gaming device 116 or components of each gaming device 116, which effectively disable the gaming devices 116 such that a game session cannot be actuated. For example, the state of gaming devices 116 may be changed from a game session available state, such as a game idle state, to a game session deactivated state in which a game session cannot be activated. It should be understood that there may be other preset criteria. For example, in the case of gaming devices which are multiplayer platforms or terminals in a sportsbook or stadium type gaming area, the preset criteria may be the number of total players using activated player positions or terminals and their respective locations.

The disabled gaming devices 116 may display an indication on their respective display devices of being temporarily disabled. Server 104 may identify another of the same or similar gaming device 116 as the disabled gaming device 116 which is available for play and display through the display device of the disabled gaming device 116 the position or location of such same or similar gaming device on the gaming floor, such as through use of the casino floor map.

To determine the gaming devices 116 that will be disabled, controller 102 considers the position of the devices, design and configuration, and may compare such information with preset criteria. The preset criteria may include a preset geographical range requirement, such as within a six foot radius of the gaming device 116, or more particularly, such as a six foot radius from the axis of the player seat location, button panel or display device on the gaming device 116. For example, in instances where the gaming device 116 is a gaming machine, the position of the machine in a bank, the design of the bank and its distance configuration are all considerations made by controller 102 when determining which adjacent gaming machines should be disabled.

When the player finishes their session, server 104 receives data from gaming device 116 to determine if any of the disabled gaming devices 116 can be re-enabled. If controller 102 has not determined these disabled gaming devices must be disabled due to game play occurring within a preset geographical range thereof, such formerly disabled devices 116 are made available again automatically.

Controller 102 provides a feature by which a cleaning notification is communicated to the appropriate staff after every gaming session ends on a gaming device 116. For example, controller 102 may send a message identifying a gaming device 116 to disinfect upon server 104 detecting a gaming session being completed at that gaming device 116, such as by receiving data in the form of SAS protocol, which may be generated by a gaming device 116 to indicate a status associated with the gaming session being completed, such as game idle, session end, credit are all lost or paid out. Controller 102 may also automatically disable the gaming device 116 in addition to sending a notification to the staff so the gaming device 116 can be cleaned and made available to the next player. Responsive to the cleaning procedure being completed, a communication may be sent via a data collection device 108, through the gaming device 116 or data collection device 114, such as through a device on the disabled gaming device 116, like inserting a card in its card reader, or through an operator interface 106 or a device 108. Upon receiving the cleaning notification in system 100, controller 102 can automatically enable the gaming device 116 for play.

Controller 102 may also be used to manually enable or disable a gaming device 116 through use of a card or mobile device, such as a PDA or smartphone which may be connected to operator interface 106.

Controller 102 can also enable reserving gaming devices 116 or a position at a gaming device 116 in advance. System 100 may receive a reservation request through a various sources of communication, such as via a remote device, such as a smartphone or computer accessing an Internet site, which communicates with controller 102 through network connection 118, through a display screen or reservation button provided at a gaming device 116, or by communicating with staff having access to system 100 through operator interface 106.

For example, a player may access a player loyalty system through a patron data collection device 114 at the casino or access a downloadable application remotely on a smartphone to create a reservation or send a reservation request. The request may indicate date, time, duration limits or expectations, which may be for planning purposes, and identify the desired gaming device 116 specifically, such as by including a game name, or as a group, such as any slot machine, any video poker, any electronic roulette or any live blackjack table. Responsive thereto, controller 102 confirms whether the request may be fulfilled based on existing reservations and planned play pursuant to other reservations, while considering factors such as cleaning time, the disabling of gaming devices 116, staff availability and player history or loyalty status, all of which may be stored in memory. Controller 102 may respond by confirming the reservation or providing alternative reservation options, and may provide reservations based on a priority associated with player loyalty status.

Controller 102 may automatically disable the gaming device 116 and other gaming devices 116 as needed in order to fulfill the reservation. Controller 102 may require information from the reservation requester such as contact information in order to send reminders by text messaging. Controller 102 may automatically disable the reserved gaming device 116 sometime before the reservation time and automatically enable the disabled gaming device for play a period of time prior to the reservation time for anyone to play, or may be set to require a player identification, such as through use of a player loyalty card. In addition to enabling the reserved gaming device 116, Controller 102 will disable any adjacent gaming devices 116 based on a comparison of their locations and application of the social distancing protocols stored in database 120. Controller 102 may offer special awards such as loyalty points or other benefits to players making reservations, or provide other features available through the reserved gaming device 116, such as higher payout probability paytables.

In some embodiments, systems and methods of the invention provide a casino management system which is communication with gaming devices available on the casino floor. The casino management system of the invention receives signals and detects gaming device activity, such as through SAS protocol signals or other communications with the casino management system which are indicative of certain types of activity, such as game idle, game session activation and deactivation, or other signals indicative of user-initiated activity or a lack of activity at a gaming device. The management system includes programming for detection of a triggering event.

Signals received from gaming devices may be compared with the triggering event to determine the appropriate response. Upon receipt of signals from gaming devices, the management system of the invention, having access to information relating to the physical locations of gaming devices or otherwise being able to determine the physical location of the gaming device from which a signal is received, the management system may determine a triggering event has occurred and respond by alternately enabling or restricting access to certain gaming devices.

For example, if the management system of the invention receives a signal which is determined to be indicative of gaming activity, the management system may restrict play on gaming devices within a certain zone or radius of the active gaming machine, such as six feet, to maintain social distancing on the gaming floor. The triggering event may also be controlled manually or upon demand, such as in instances where an incident near a gaming machine occurs that warrants restricting access to adjacent gaming machines as a means for keeping others away from the area.

The system may be configured to cause the condition of restricted gaming devices to change, such as by causing the devices to appear visually different, display a message or otherwise display a change. The system may shut down the device partially or completely, such as shutting down certain components like the bill acceptor or player loyalty card reader. The system may also change the appearance by turning on, off or changing the illumination of the gaming device housing lighting, candle light or other components, such as changing the illumination of the player loyalty card reader.

The management system may thereafter receive signals indicative of the cessation of user activity, such as a signal indicating that the gaming device is idle. The system may implement a countdown or otherwise remove the restricted condition of any gaming devices so that these gaming devices are enabled for play. Upon being enabled, any change in appearance implemented to indicate the change in condition will be removed so that the gaming devices return to their normal appearance and are accessible for play. The gaming device may also display some indication, such as a message on its display device, indicating that the gaming device is available for play.

In some embodiments, the management system of the invention may communicate to deploy staff in order for the staff to disinfect the gaming devices prior to or after re-enabling the gaming device. For example, a subject electronic gaming machine being played may cause the restrictions of adjacent machines as determined by the system of the invention, and upon play ceasing the subject machine may remain restricted by the management system while other adjacent gaming machines are re-enabled. This may be used to allow for staff to receive a communication generated by the management system identifying the subject gaming machine as being in need of cleaning and disinfecting prior to the gaming machine being re-enabled. Similarly, the management system may store data on gaming machine activity and periodically restrict gaming devices based on use to enable the gaming devices to be cleaned and disinfected, or for other reasons.

In other embodiments, the management system may be configured to restrict or enable play for various purposes, such as to drive play of certain machines or in particular areas of the casino floor by restricting or enabling such machines without occurrence of a triggering event. The management system may also reserve machines by enabling the reserved machines and restricting adjacent machines. The reservation may be made upon demand or in advance so that the management system acts at a prearranged time. Similarly, gaming machines in certain areas of the casino may be restricted or enabled at various times and period of the day. For example, areas of the gaming floor in need of disinfecting may be restricted while being cleaned.

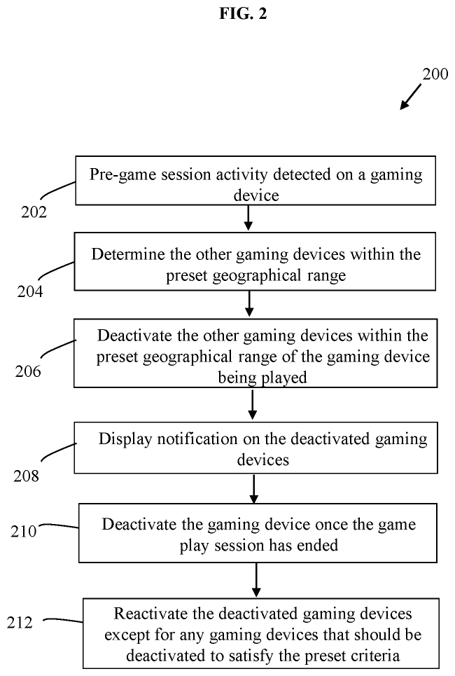

An exemplary process or method of the invention is shown in FIG. 2 and generally identified by reference number 200. For ease in description and illustration the method is discussed herein in connection with a system such as system 100.

As shown by step 202, controller 102 detects pre-game session activity on a gaming device 116 caused by a user selecting to initiate a game session on the gaming device 116, such as by establishing credit in the memory or accounting system of the gaming device 116. In step 204, the controller 102 determines based on the gaming floor map the gaming devices 116 within a preset geographical range of the selected gaming device 116. Assuming the preset criteria is established because the game device 116 is not indicated as being unavailable, step 206, controller 102 causes the state of the gaming devices 116 within the preset geographical range to enter into a game session deactivation state, which may involve alternating the gaming devices 116 from a game idle or available state or condition into a deactivated state or condition.

In some embodiments, should a game session not begin on the gaming device 116 in which pre-game session activity is detected after a preset period of time, controller 102 may deactivate the gaming device in which the pre-game session activity is detected and reactivate the deactivated gaming devices 116.

It should be understood that in certain circumstances a gaming device 116 may not be indicated as being deactivated and seemingly be available to play yet controller 102 may determine that the preset criteria is not satisfied after detecting pre-game session activity. For example, this could happen if a different player on another gaming device 116 begin pre-game activity earlier, or should a reservation made which would impact the determination of the preset criteria occur or be set to occur within a preset period of time, such as within the next five minutes. In the latter case, controller may cause a display indicating that the gaming device 116 may be available should the reservation not be fulfilled in time.

In step 208, controller 102 communicates with the deactivated gaming devices 116, such as through communication with the internal operating hardware and software in or associated with each deactivated gaming device 116, to cause a display on the display device notifying that a game cannot be played on the gaming device 116. Controller 102 may also determine the same game or type which is available for play on another one or more alternative gaming devices 116 at the casino and provide a display of the map of the gaming floor showing the location of the alternative gaming devices 116. Controller 102 may also display on the display device of the deactivated machine an offer to reserve alternative gaming devices 116 as discussed herein for a period of time for the player to make use of the reservation. The offer may instruct the player to make the reservation through the deactivated gaming device 116, casino personnel, a website or through a downloadable software application for a mobile device such as a smartphone.

As shown by step 210, once controller 102 detects the cessation of a game session, controller 102 puts the gaming device 116 in a deactivated state, which among other things, enables cleaning thereof. As shown by step 212, once controller 102 causes gaming device 116 to be in a deactivated state, controller 102 causes the deactivated gaming devices 116 to return to an active state, except for any of these gaming devices 116 that may be within the preset geographical range of another gaming device 116 currently in an active state. The formerly activate gaming device 116 now in a deactivated state may remain in the deactivated state until casino personnel indicate the gaming device 116 as being cleaned. Responsive thereto controller 102 will then change the state to make this gaming device 116 available for game play, that is, unless the gaming device 116 is within the preset geographical range of a different gaming device 116 currently in an active state.

It should be readily apparent that the systems and methods of the invention may be deployed in connection with any gaming devices. Gaming devices is intended to include any gaming activity occurring at a gaming establishment, including electronic gaming machines, slot machines and gaming platforms of any kind, as well as kiosks, electronic and non-electronic live gaming tables, sportsbooks, keno, e-sports and gaming terminals.

Those skilled in the art will also readily appreciate that such a system configured in accordance with this invention may include or employ various specialized and/or non-specialized computer and network related software and hardware, such as software and hardware which are used in a distributed computing network, that is, programs, operating systems, memory storage devices, input/output devices, data processors, servers with communication links, wireless or otherwise, such as those which take the form of a local or wide area network, and a plurality of data terminals within the network, such as personal computers and mobile devices.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality. However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “determining,” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

Some embodiments also relate to an apparatus for performing the operations herein. Such an apparatus may be specially constructed for the purposes, e.g., a specific computer, or it may comprise a general-purpose computer specially customized, selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers or servers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

Those skilled in the art will appreciate that the types of software and hardware used are not vital to the full implementation of the methods of the invention. The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Additional information regarding features of exemplary embodiments of the invention is provided below.

In some embodiments, the methods, systems, and media disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

In some embodiments, the methods, systems, and media disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, the methods, systems, and media disclosed herein include one or more databases, or use of the same. In view of the disclosure provided herein, those of skill in the art will recognize that many databases are suitable for storage and retrieval of player and game information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based.

In still further embodiments, a database is cloud computing-based. In other embodiments, a database is based on one or more local computer storage devices.

A controller, computing device, computer or server, such as described herein, may include at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

In some embodiments, a controller may include a processor, which as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

While exemplary apparatus, systems and methods of the invention have been described herein and in the accompanying documents, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth herein, by the claims and any equivalents thereto.

1. A system for monitoring and controlling one or more gaming devices on a gaming floor, the system comprising:
one or more gaming devices positioned on the gaming floor, wherein the gaming devices are interconnected by a network; and
a gaming device controller, including one or more data processors, memory and a data communication device, the gaming device controller being interconnected with the one or more gaming devices and a data storage device by the network, the data storage device storing a map of the gaming floor with a game identification of each gaming device and the position of the one or more gaming devices on the gaming floor, wherein the gaming device controller is configured to detect data transmissions generated by the one or more gaming devices, the transmissions being indicative of a game session activity, a pre-game session activity, a game session available state, a game session active state and a game session deactivation state,
wherein the gaming device controller is configured to alternate the state of the one or more gaming devices at least between the game session available state and the game session deactivation state,
wherein the game session available state enables a user-initiated activation of a game session on the one or more gaming devices and the game session deactivation state disables the one or more gaming devices for the user-initiated activation of a game session, and wherein responsive to the gaming device controller detecting the pre-game session activity on a selected gaming device of the one or more gaming devices in the game session available state, the gaming device controller enabling the selected gaming device for a game session responsive to a determination based on the map that the selected gaming device and a one or more unselected gaming devices satisfy a preset criteria, the gaming device controller alternating the state of the one or more unselected gaming devices to the game session deactivation state responsive to the preset criteria being satisfied.

2. The system of claim 1, wherein the preset criteria is satisfied responsive to the one or more unselected gaming devices being in the game session available state or the game session deactivation state.

3. The system of claim 1, wherein the preset criteria comprises a geographical range of the one or more unselected gaming devices relative to the geographical location of the selected gaming device being in the game session available state or the game session deactivation state, wherein the gaming device controller alternates the state of only the one or more unselected gaming devices within the geographical range to the game session deactivation state responsive to the preset criteria being satisfied.

4. The system of claim 3, wherein responsive to the preset criteria being satisfied, the gaming device controller actuates a visual indication of the game session deactivation state on a display device associated with the one or more unselected gaming devices within the geographical range.

5. The system of claim 4, wherein the gaming device controller determines based on the map an alternative gaming device having the same game identification as the one or more unselected gaming devices within the geographical range.

6. The system of claim 5, wherein the gaming device controller actuates a visual indication of the position on the gaming floor of the alternative gaming device on a display device associated with the one or more unselected gaming devices within the geographical range.

7. The system of claim 1, wherein the gaming device controller is further configured to alternate the state of the selected gaming device to the game session deactivation state responsive to the gaming device controller detecting the cessation of game session activity on the selected gaming device.

8. The system of claim 7, wherein the gaming device controller is further configured to alternate the state of the one or more unselected gaming devices within the geographical range to the game session available state responsive to the gaming device controller alternating the state of selected gaming device to the game session deactivation state and the preset criteria being satisfied.

9. The system of claim 1, wherein the gaming device controller is further configured to receive an identification of the selected gaming device of the one or more gaming devices, a date and a time, and responsive thereto, alternate the state of the selected gaming device and the one or more unselected gaming devices to a game session deactivation state.

10. The system of claim 1, wherein the pre-game session activity comprises receiving a signal indicative of establishing credit on the selected gaming device.

11. The system of claim 1, wherein the pre-game session activity comprises a detection of physical contact with a user interface on the selected gaming device.

12. A system for monitoring and controlling one or more gaming devices on a gaming floor, the system comprising:
one or more gaming devices positioned on the gaming floor, wherein the gaming devices are interconnected by a network; and
a gaming device controller, including one or more data processors and a data communication device, the gaming device controller being interconnected with the one or more gaming devices and a data storage device by the network, the data storage device storing a map of the gaming floor with an identification of each gaming device and the position of the one or more gaming devices on the gaming floor,
wherein the gaming device controller is configured to detect data transmissions generated by the one or more gaming devices, the transmissions being indicative of a game session activity, a pre-game session activity, a game session available state, a game session active state and a game session deactivation state,
wherein the gaming device controller is configured to alternate the state of the one or more gaming devices at least between the game session available state and the game session deactivation state,
wherein the game session available state enables a user-initiated activation of a game session on the one or more gaming devices and the game session deactivation state disables the one or more gaming devices for the user-initiated activation of a game session,
wherein responsive to the gaming device controller detecting the pre-game session activity on a selected gaming device of the one or more gaming devices in the game session available state, the gaming device controller enabling the selected gaming device for a game session responsive to a determination based on the map that the selected gaming device and a one or more unselected gaming devices satisfy a preset criteria comprising a geographical range of the one or more unselected gaming devices relative to the geographical location of the selected gaming device being in the game session available state or the game session deactivation state, wherein the gaming device controller alternates the state of the one or more unselected gaming devices within the geographical range to the game session deactivation state responsive to the preset criteria being satisfied.

13. The system of claim 12, wherein responsive to the preset criteria being satisfied, the gaming device controller actuating a visual indication of the game session deactivation state on a display device associated with the one or more unselected gaming devices within the geographical range.

14. The system of claim 13, wherein the visual indication further comprises an alternative gaming device in the game session available state of the one or more unselected gaming devices.

15. The system of claim 13, wherein the gaming device controller is further configured to alternate the state of the selected gaming device to the game session deactivation state responsive to the gaming device controller detecting the cessation of game session activity on the selected gaming device.

16. The system of claim 15, wherein the gaming device controller is further configured to alternate the state of the one or more unselected gaming devices within the geographical range to the game session available state responsive to the gaming device controller alternating the state of selected gaming device to the game session deactivation state and the preset criteria being satisfied.

17. The system of claim 12, wherein the gaming device controller is further configured to receive an identification of the selected gaming device of the one or more gaming devices, a date and a time, and responsive thereto, alternate the state of the selected gaming device and the one or more unselected gaming devices to a game session deactivation state.

18. A method for monitoring and controlling one or more gaming devices on a gaming floor in a casino having one or more gaming devices positioned on the gaming floor, wherein the gaming devices are interconnected by a network, and a gaming device controller, including one or more data processors and a data communication device, the gaming device controller being interconnected with the one or more gaming devices and a data storage device by the network, the data storage device storing a map of the gaming floor with an identification of each gaming device and the position of the one or more gaming devices on the gaming floor, wherein the gaming device controller is configured to detect data transmissions generated by the one or more gaming devices, the transmissions being indicative of a game session activity, a pre-game session activity, a game session available state, a game session active state and a game session deactivation state, wherein the gaming device controller is configured to alternate the state of the one or more gaming devices at least between the game session available state and the game session deactivation state, wherein the game session available state enables a user-initiated activation of a game session on the one or more gaming devices and the game session deactivation state disables the one or more gaming devices for the user-initiated activation of a game session, the method comprising the steps of:
a) responsive to the gaming device controller detecting pre-game session activity on a selected gaming device of the one or more gaming devices in the game session available state, the gaming device controller determining based on the map that the selected gaming device and a one or more unselected gaming devices satisfy a preset criteria;
b) the gaming device controller alternating the state of the one or more unselected gaming devices to the game session deactivation state responsive to the preset criteria being satisfied;
c) the gaming device controller actuating a visual indication of the game session deactivation state on a display device associated with the one or more unselected gaming devices;
d) the gaming device controller alternating the state of the selected gaming device to the game session deactivation state responsive to the gaming device controller detecting the cessation of game session activity on the selected gaming device; and
e) the gaming device controller alternating the state of the one or more unselected gaming devices to the game session available state responsive to the gaming device controller alternating the state of selected gaming device to the game session deactivation state and the preset criteria being satisfied.

19. The method of claim 18, wherein the preset criteria comprises a geographical range of the one or more unselected gaming devices relative to the geographical location of the selected gaming device being in the game session available state or the game session deactivation state, wherein the gaming device controller alternates the state of only the one or more unselected gaming devices within the geographical range to the game session deactivation state responsive to the preset criteria being satisfied.
